(19) United States
(12) Patent Application Publication
(10) Pub. No.: US 2018/0193936 A1
(43) Pub. Date: Jul. 12, 2018

(54) Electrical Discharge Machining Method And Apparatus

(71) Applicants: BOE TECHNOLOGY GROUP CO., LTD., Beijing (CN); BOE OPTICAL SCIENCE AND TECHNOLOGY CO., LTD., Jiangsu (CN)

(72) Inventors: Zipeng Chen, Beijing (CN); Zhongliang Li, Beijing (CN)

(21) Appl. No.: 15/563,247

(22) PCT Filed: Mar. 1, 2017
(86) PCT No.: PCT/CN2017/075315

§ 371 Date: Sep. 29, 2017

(30) Foreign Application Priority Data
May 5, 2016 (CN) 201610292053.4

(51) Int. Cl. B23H 7/26; B23H 7/20; B23H 1/06; B23H 1/08

(52) U.S. Cl. CPC B23H 7/26; B23H 1/08; B23H 1/06; B23H 7/20

(57) ABSTRACT

The present disclosure discloses an electrical discharge machining method, comprising: mounting an electrode blank on an electrode holder; mounting the electrode holder with the electrode blank on a chuck of a computer numerical control machine; processing the electrode blank into an electrode using the computer numerical control machine; mounting the electrode holder with the processed electrode on an EDM chuck of an electrical discharge machine; using the electrode to perform electrical discharge machining on a workpiece to be processed.

### CROSS-REFERENCE TO RELATED APPLICATION

This application claims the priority of Chinese Patent Application No. 201610292053.4 filed on May 5, 2016, the entire contents of which are hereby incorporated by reference in their entirety as part of this application.

### TECHNICAL FIELD

The present disclosure relates to the field of electrical discharge machining, and more particularly to an electrical discharge machining method and apparatus.

### BACKGROUND

In manufacturing a mold, the electrical discharge with an electrode is an essential process. For this reason, it is necessary to first machine the electrode on a computer numerical control (CNC) machine tool, and then install the machined electrode on an electrical discharge machine to perform electrical discharge machining on the mold.

The traditional CNC machining process of an electrode is to clamp the electrode with a vise, and in each processing it needs to be centered and positioned. The machined electrode needs to be mounted on the electrical discharge machining (EDM) chuck of the electrical discharge machine and needs to be adjusted using an electrode adjusting device, in order to adjust the orientation of the electrode, and find the center of the electrode, in which process, a lot of time has to be wasted, reducing the efficiency, and it is still difficult to guarantee positioning accuracy.

### SUMMARY

In one aspect of the present disclosure, there is provided an electrical discharge machining method, comprising: mounting an electrode blank on an electrode holder; mounting the electrode holder with the electrode blank on a chuck of a computer numerical control machine; processing the electrode blank into an electrode using the computer numerical control machine; mounting the electrode holder with the processed electrode on an electrical discharge machining chuck of an electrical discharge machine; and using the electrode to perform electrical discharge machining on a workpiece to be processed.

According to an exemplary embodiment of the present disclosure, the electrode holder includes a holder body and a chucking spigot fixed to the bottom of the holder body, the holder body being configured to be capable of mounting and fixing an electrode thereon, the chucking spigot being configured to be capable of being mounted and fixed to the chuck of the computer numerical control machine and being configured to be capable of being mounted and fixed to the electrical discharge machining chuck of the electrical discharge machine.

According to an exemplary embodiment of the present disclosure, the workpiece to be processed is a mold to be processed.

According to an exemplary embodiment of the present disclosure, the chuck, electrode holder and electrical discharge machining chuck are manufactured to match each other.

In another aspect of the present disclosure, there is provided an electrical discharge machining apparatus, comprising: an electrode holder configured to mount an electrode blank thereon; a chuck of a computer numerical control machine configured to mount thereon an electrode holder with the blank electrode, so that the electrode blank is processed into an electrode by the computer numerical control machine; and an electrical discharge machining chuck of an electrical discharge machine configured to mount the electrode holder with the processed electrode thereon, so that the electrical discharge machine performs electrical discharge machining on a workpiece to be processed using the electrode.

According to an exemplary embodiment of the present disclosure, the electrode holder includes a holder body and a chucking spigot fixed to the bottom of the holder body, the holder body being configured to be capable of mounting and fixing an electrode blank thereon, the chucking spigot being configured to be capable of being mounted and fixed to the chuck of the computer numerical control machine and configured to be capable of being mounted and fixed to the electrical discharge machining chuck of the electrical discharge machine.

According to an exemplary embodiment of the present disclosure, the electrical discharge machining apparatus further comprises: the computer numerical control machine; and the electrical discharge machine.

According to an exemplary embodiment of the present disclosure, the workpiece to be processed is a mold to be processed.

According to an exemplary embodiment of the present disclosure, the chuck, electrode holder and electrical discharge machining chuck are manufactured to match each other.

According to the technical solution of the present disclosure, by using the electrode holder, replacing the center of the electrode with the center of the electrode holder, a single clamping and fast positioning are realized, thereby avoiding the drawbacks of having to repetitively align the electrode in the prior art, eliminating the resulting downtime, improving the productivity, making production automation possible, and improving the positioning accuracy and processing quality.

### BRIEF DESCRIPTION OF THE DRAWINGS

FIG. 1 shows a discharge machining apparatus according to an embodiment of the present disclosure;

FIG. 2 shows a discharge machining method according to an embodiment of the present disclosure.

### DETAILED DESCRIPTION OF SPECIFIC EMBODIMENTS

For the purpose of obtaining a better understanding of the solutions of the present disclosure by those skilled in the art, specific embodiments of the embodiments of the present disclosure will now be described in further detail with reference to the accompanying drawings. It is obvious that the described embodiments are part of the present application, not all embodiments. All other embodiments obtained by one of ordinary skill in the art based on the described embodiments of the present disclosure without paying inventive effort are within the scope of this disclosure.

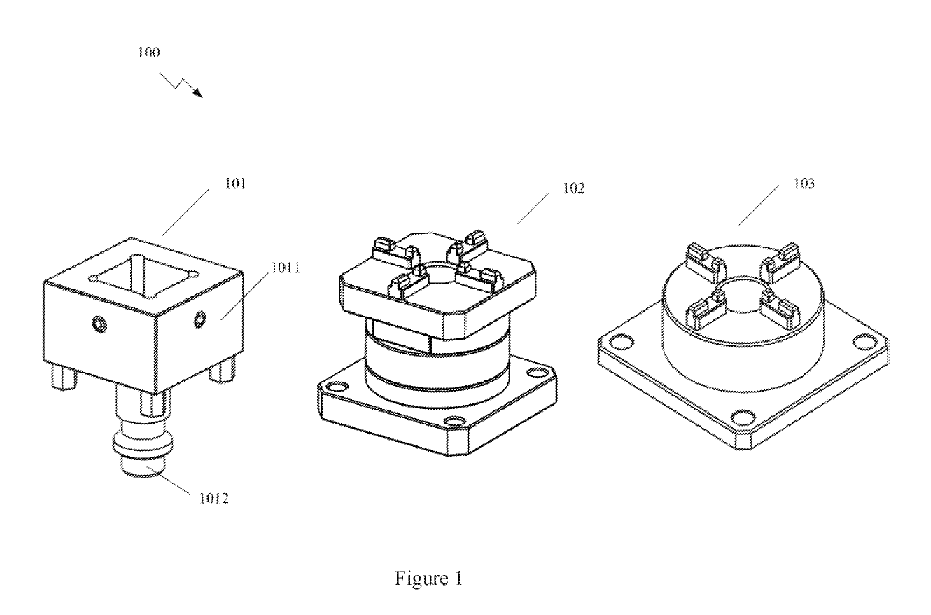

Referring now to FIG. 1, there is shown a discharge machining apparatus 100 according to an embodiment of the present disclosure. As shown, the discharge machining apparatus 100 includes an electrode holder 101 configured to mount an electrode blank thereon; a chuck 102 of a CNC machine configured to mount the electrode holder with the electrode blank, so that the electrode blank is processed into an electrode by the computer numerical control machine, and an EDM chuck 103 of an electrical discharge machine configured to mount the electrode holder with the processed electrode thereon, so that the electrical discharge machine performs electrical discharge machining on the workpiece to be processed using the electrode.

According to the technical solution of the electrical discharge machining apparatus, when the CNC machine is used to process the electrode, the chuck 102 of the CNC machine is fixed, aligned and clamped on the work surface of the CNC machine, and the electrode blank is mounted on the electrode holder 101 outside the machine, for example, screwed down with fixing screws, and then the electrode holder 101 is fixed to the chuck 102 of the CNC machine, the center of the electrode holder 101 is determined using a measuring pointer on the four sides thereof, and no further center determination is required during subsequent processing. After the electrode processing is completed, the electrode holder 101 is directly removed and then clamped on the EDM chuck 103 of the electrical discharge machine. There is no need to align the electrode again, and during the process the center of the electrode remains unchanged.

The electrical discharge machining technical solution uses the electrode holder 101, replacing the center of the electrode with the center of the electrode holder 101, thus realizing a single clamping and fast positioning so as to avoid the shortcomings of the prior art requiring repeated alignment of the electrode, eliminate the resulting downtime, and improve work efficiency. Moreover the workpieces are all installed outside the machine, the compensation value can also be measured outside the machine, so as to make production automation possible.

According to an exemplary embodiment of the present disclosure, as shown in FIG. 1, the electrode holder 101 includes a holder body 1011 and a chucking spigot 1012 fixed to the bottom of the holder body 1011, the holder body 1011 being configured to be capable of mounting and fixing an electrode thereon, the chucking spigot 1012 being configured to be capable of being mounted and fixed to the chuck 102 of the CNC machine, and being configured to be capable of being mounted and fixed to the EDM chuck 103 of the electrical discharge machine.

The holder body 1011 may have any shape, size and structure suitable for mounting and fixing an electrode and suitable to be positioned. For example, the holder body 1011 may have a cavity suitable for receiving an electrode, multiple fixing screws or other fixing mechanisms for fixing the electrode, a connection mechanism (e.g., a screw hole) for connecting and fixing the chucking spigot 1012, and multiple support screws for contacting the flat surface of the chuck or EDM chuck to be connected to facilitate the Z-axis positioning.

The chucking spigot 1012 may be fixed to the holder body 1011, for example, by screw connection or the like. In an embodiment of the present disclosure, the chucking spigot 1012 may be a chucking spigot conforming to a standard so that it can be mounted and fixed to a chuck of a CNC machine and an EDM chuck of an electrical discharge machine that conform to the same standard. For example, the chucking spigot 1012 may be a chucking spigot compatible with the Erowa workpiece holding system such that the electrode holder 101 may be referred to as an Erowa holder and may be mounted on any Erowa compliant chuck and EDM chuck.

As the Erowa holder has a high repetitive positioning accuracy, for example, up to 0.002 mm, and its four support screws with the same height ensure the Z-axis accuracy, it can be guaranteed that the three center points of the chuck of the CNC machine, the Erowa holder, and the EDM chuck are in a straight line, thus improving the positioning accuracy and processing quality.

According to an exemplary embodiment of the present disclosure, the electrical discharge machining apparatus 100 further comprises: the CNC machine; and the electrical discharge machine.

According to an exemplary embodiment of the present disclosure, the workpiece to be processed is a mold (or die) to be processed.

According to an exemplary embodiment of the present disclosure, the chuck 102, the electrode holder 101 and the EDM chuck 103 are manufactured to match each other. For example, they may be manufactured by the same manufacturer to match each other, or by different manufacturers using the same standard (such as the Erowa standard) to match each other.

The electrical discharge machining apparatus according to the embodiments of the present disclosure has been described above with reference to the accompanying drawings, and it is to be noted that the above description is by way of example only and is not intended to be limiting of the present disclosure. In other embodiments of the present disclosure, the electrical discharge machining apparatus may have more, fewer or different components, and the relationships of inclusion, connection and function among the components may be different from what has been described and illustrated. For example, generally a plurality of components may also be considered as a larger component, and a plurality of sub-components contained in one component may also be considered as a plurality of individual components. Further, for example, the positional relationships among the components described above and illustrated in the drawings are not to be construed as limiting the present disclosure. Also, for example, the features included in the above exemplary embodiments may generally be combined with one another in any manner known to those skilled in the art to form a new embodiment.

In another aspect of the disclosure, there is further provided an electrical discharge machining method. The electrical discharge machining method can be carried out by the above-described electrical discharge machining apparatus according to an embodiment of the present disclosure. For the sake of brevity, some details repeated with the above description are omitted from the following description, and a more detailed understanding of the electrical discharge machining method according to embodiments of the present disclosure can be obtained with reference to the above description.

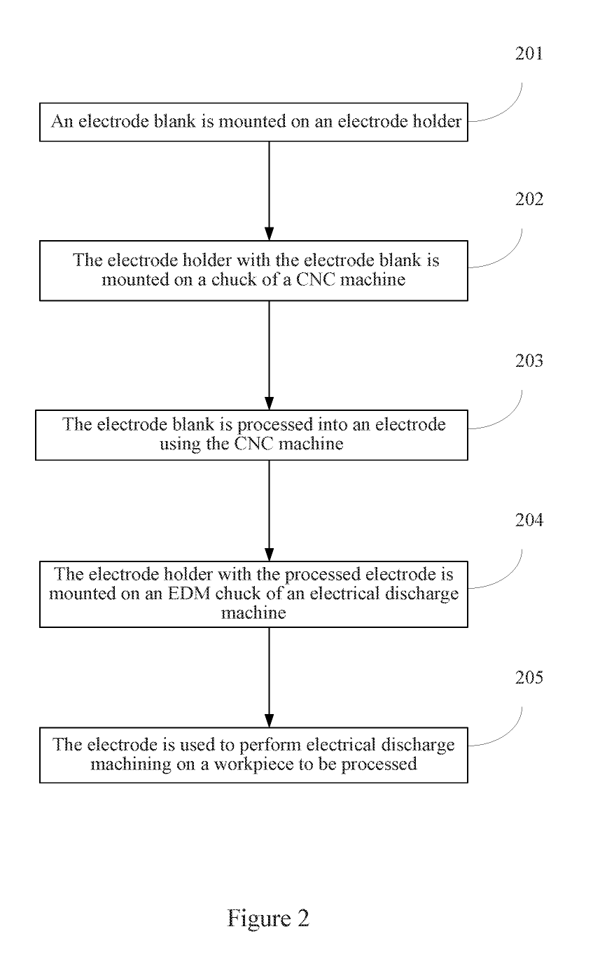

Referring now to FIG. 2, there is shown an electrical discharge machining method according to an embodiment of the present disclosure. As shown, the method comprises the following steps:

In step 201, an electrode blank is mounted on an electrode holder;

In step 202, the electrode holder with the electrode blank is mounted on a chuck of a CNC machine;

In step 203, the electrode blank is processed into an electrode using the CNC machine;

In step 204, the electrode holder with the processed electrode is mounted on an EDM chuck of an electrical discharge machine;

In step 205, the electrode is used to perform electrical discharge machining on a workpiece to be processed.

According to the technical solution of the electrical discharge machining method, when the CNC machine is used to process the electrode, the chuck of CNC machine is fixed, aligned and clamped on the work surface of CNC machine, and the electrode blank is mounted on the electrode holder outside the machine, for example, screwed down with fixing screws, and then the electrode holder is fixed to the chuck of the CNC machine, the center of the electrode holder 101 is determined using a measuring pointer on the four sides thereof, and no further center determination is required during subsequent processing. After the electrode processing is completed, the electrode holder is directly removed and then clamped on the EDM chuck of the electrical discharge machine. There is no need to align the electrode again, and during the process, the center of the electrode remains unchanged.

The electrical discharge machining technical solution uses the electrode holder, replacing the center of the electrode with the center of the electrode holder, thus realizing a single clamping and fast positioning, so as to avoid the shortcomings of the prior art requiring repeated alignment of the electrode, completely eliminate the resulting downtime, and improve work efficiency. Moreover the workpieces are all installed outside the machine, the compensation value can also be measured outside the machine, so as to make production automation possible.

According to an exemplary embodiment of the present disclosure, the electrode holder includes a holder body and a chucking spigot fixed to the bottom of the holder body, the holder body being configured to be capable of mounting and fixing an electrode thereon, the chucking spigot being configured to be capable of being mounted and fixed on the chuck of the computer numerical control machine and being configured to be capable of being mounted and fixed to the EDM chuck of the electrical discharge machine.

The chucking spigot may be a chucking spigot compatible with the Erowa workpiece holding system, such that the electrode holder 101 may be referred to as an Erowa holder and may be mounted on any Erowa compliant chuck and EDM chuck. As the Erowa holder has a high repetitive positioning accuracy, for example, up to 0.002 mm, and its four support screws with the same height ensure the Z-axis accuracy, it can be guaranteed that the three center points of the chuck of the CNC machine, the Erowa holder, and the EDM chuck are in a straight line, thus improving the positioning accuracy and processing quality.

According to an exemplary embodiment of the present disclosure, the workpiece to be processed is a mold (or die) to be processed.

According to an exemplary embodiment of the present disclosure, the chuck, the electrode holder and the EDM chuck are manufactured to match each other.

The electrical discharge machining method according to the embodiments of the present disclosure has been described above with reference to the accompanying drawings, and it is to be noted that the above description is by way of example only and is not intended to be limiting of the present disclosure. In other embodiments of the present disclosure, the method may have more, fewer or different steps, and the relationships of order, inclusion, and function among the steps may be different from those described and illustrated. For example, generally a plurality of steps may also be considered as a larger step, and a plurality of sub-steps included in one step may be considered as a plurality of individual steps. Further, for example, the order of the steps in the above description and illustrations in general does not constitute a limitation to the method of the present disclosure, and the steps may be performed in any order or concurrently as known to those skilled in the art. Also, for example, the features included in the above exemplary embodiments may generally be combined with each other in any manner as known to those skilled in the art to form a new embodiment.

It is to be understood that the above embodiments of the present disclosure are merely exemplary embodiments for the purpose of illustrating the principles of the present disclosure, which is not limited thereto. It will be apparent to those skilled in the art that various changes and modifications may be made therein without departing from the spirit and essence of the present disclosure, which changes and modifications are also intended to be within the scope of the present disclosure. The scope of the present disclosure is limited only by the meaning of the language expressions of the appended claims and their equivalents.

1. An electrical discharge machining method, comprising:
mounting an electrode blank on an electrode holder;
mounting the electrode holder with the electrode blank on a chuck of a computer numerical control machine;
processing the electrode blank into an electrode using the computer numerical control machine;
mounting the electrode holder with the processed electrode on an electrical discharge machining chuck of an electrical discharge machine;
using the electrode to perform electrical discharge machining on a workpiece to be processed.

2. The electrical discharge machining method according to claim 1, wherein the electrode holder includes a holder body and a chucking spigot fixed to the bottom of the holder body, the holder body being configured to be capable of mounting and fixing an electrode thereon, the chucking spigot being configured to be capable of being mounted and fixed to the chuck of the computer numerical control machine and configured to be capable of being mounted and fixed to the electrical discharge machining chuck of the electrical discharge machine.

3. The electrical discharge machining method according to claim 1, wherein the workpiece to be processed is a mold to be processed.

4. The electrical discharge machining method according to claim 1, wherein the chuck, electrode holder and electrical discharge machining chuck are manufactured to match each other.

5. An electrical discharge machining apparatus, comprising:
an electrode holder configured to mount an electrode blank thereon;
a chuck of a computer numerical control machine configured to mount the electrode holder with the electrode blank thereon, so that the electrode blank is processed into an electrode by the computer numerical control machine; and
an electrical discharge machining chuck of an electrical discharge machine configured to mount the electrode holder with the processed electrode thereon, so that the electrical discharge machine performs electrical discharge machining on a workpiece to be processed using the electrode.

6. The electrical discharge machining apparatus according to claim 5, wherein the electrode holder includes a holder body and a chucking spigot fixed to the bottom of the holder body, the holder body being configured to be capable of mounting and fixing an electrode blank thereon, the chucking spigot being configured to be capable of being mounted and fixed to the chuck of the computer numerical control machine and configured to be capable of being mounted and fixed to the electrical discharge machining chuck of the electrical discharge machine.

7. The electrical discharge machining apparatus according to claim 5, further comprising:
the computer numerical control machine; and
the electrical discharge machine.

8. The electrical discharge machining apparatus according to claim 5, wherein the workpiece to be processed is a mold to be processed.

9. The electrical discharge machining apparatus according to claim 5, wherein the chuck, electrode holder and electrical discharge machining chuck are manufactured to match each other.
